(19) United States
(12) Patent Application Publication
(10) Pub. No.: US 2017/0283000 A1
(43) Pub. Date: Oct. 5, 2017

(54) Bicycle brake shoe assembly

(71) Applicants: Shao-Wei Huang, Changhua City (TW); Ming-Ju Chiang, Changhua City (TW); Jui-Te Wu, Changhua City (TW)

(72) Inventors: Shao-Wei Huang, Changhua City (TW); Ming-Ju Chiang, Changhua City (TW); Jui-Te Wu, Changhua City (TW)

(21) Appl. No.: 15/623,385

(22) Filed: Jun. 15, 2017

(51) Int. Cl. B62L 1/00

(52) U.S. Cl. CPC B62L 1/005

(57) ABSTRACT

A bicycle brake shoe device is provided with a brake pad assembly including right and left members on an inner surface respectively wherein the left member has a cavity, and two grooves on top and bottom of the right and left members respectively; a support including an intermediate hole, two grooved rails on top and bottom of an inner surface respectively, and a threaded hole through a right side; a bolt and nut assembly including a nut in the intermediate hole, and a bolt driven through the nut to fasten the bolt and nut assembly and the support together wherein the brake pad assembly and the support are positioned and the grooves are disposed in the grooved rails respectively; and a screw driven through the threaded hole into a hole of the right member to fasten the support and the brake pad assembly together.

### BACKGROUND OF THE INVENTION

### 1. Field of the Invention

The invention relates to bicycle brake shoe assemblies and more particularly to a brake shoe assembly for a bicycle having improved characteristics.

### 2. Description of Related Art

A conventional bicycle brake shoe assembly comprising a support, a brake pad secured to the support, and a threaded stud secured to the support. The brake pad is made of friction material for frictionally engaging a rim for slowing or stopping the bicycle.

However, replacement of the worn brake pad is difficult because the brake pad, the support, and the stud are secured in a complicated way.

Thus, the need for improvement still exists.

### SUMMARY OF THE INVENTION

It is therefore one object of the invention to provide a brake shoe device for a bicycle comprising a brake pad assembly including a surface, right and left limit members on an opposite surface respectively wherein the left limit member has a cavity and the right limit member has a hole, and two grooves on top and bottom of the limit members respectively; a support including an intermediate hole, two grooved rails on top and bottom of an inner surface respectively, and a threaded hole through a right side; a bolt and nut assembly including a nut in the intermediate hole, and a bolt driven through the nut to fasten the bolt and nut assembly and the support together wherein the brake pad assembly and the support are positioned and the grooves are disposed in the grooved rails respectively; and a threaded fastener driven through the threaded hole into the hole of the right limit member to fasten the support and the brake pad assembly together.

The above and other objects, features and advantages of the invention will become apparent from the following detailed description taken with the accompanying drawings.

### BRIEF DESCRIPTION OF THE DRAWINGS

FIG. 1 is a perspective view of a bicycle brake pad assembly according to the invention;

FIG. 2 is an exploded perspective view of a first preferred embodiment of a bicycle brake shoe device of the invention;

FIG. 3 is a sectional view of the assembled bicycle brake shoe device;

FIG. 4 is an exploded perspective view of a second preferred embodiment of a bicycle brake shoe device of the invention;

FIG. 5 is a sectional view of the assembled bicycle brake shoe device of FIG. 4; and

FIG. 6 is a detailed view of a circle in FIG. 5.

### DETAILED DESCRIPTION OF THE INVENTION

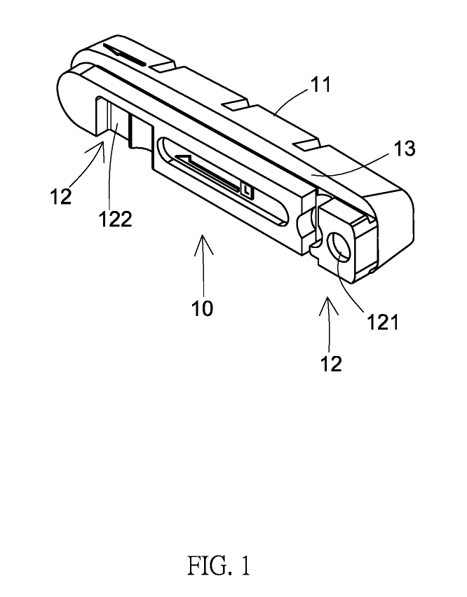

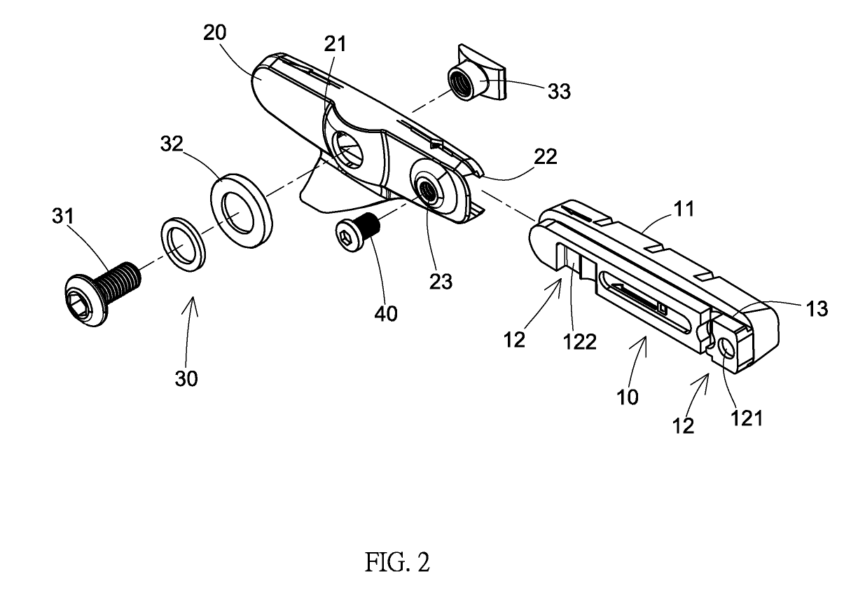

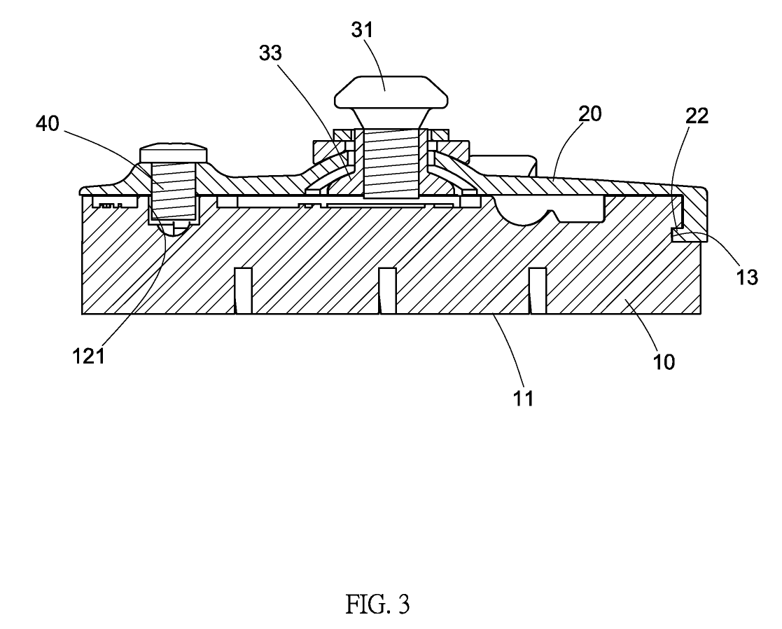

Referring to FIGS. 1 to 3, a brake shoe device for a bicycle in accordance with a first preferred embodiment of the invention comprises the following components as discussed in detail below.

A brake pad assembly 10 includes a surface 11 facing a rim of a bicycle wheel, two limit members 12 on left and right sides of an opposite surface respectively in which the left limit member 12 has a cavity 122 and the right limit member 12 has a hole 121, and two grooves 13 on top and bottom of the limit members 12 respectively.

A support 20 includes an intermediate hole 21, two grooved rails 22 on top and bottom of an inner surface respectively, and a threaded hole 23 through the right side.

A bolt and nut assembly 30 includes a washer 32, a nut 33 in the intermediate hole 21, and a bolt 31 driven through the washer 32 and the nut 33 to fasten the bolt and nut assembly 30 and the support 20 together.

The brake pad assembly 10 and the support 20 are positioned by sliding the grooves 13 along the grooved rails 22 respectively. Further, a screw 40 is driven through the threaded hole 23 into the hole 121 to fasten the support 20 and the brake pad assembly 10 together.

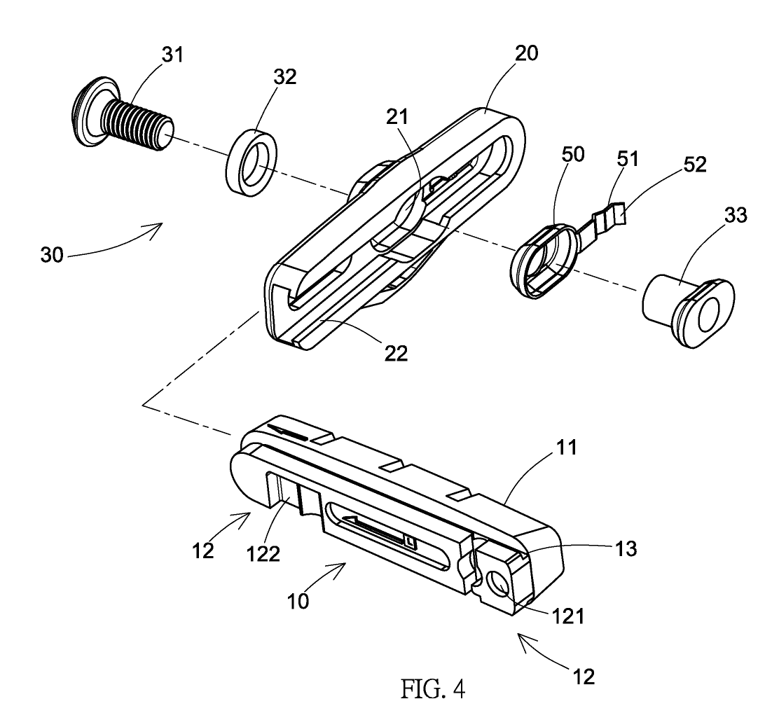

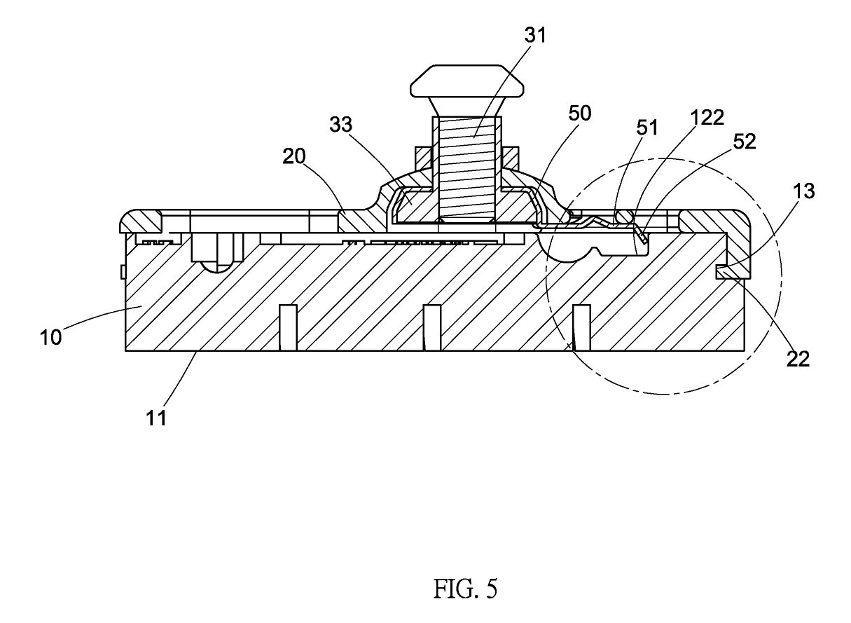

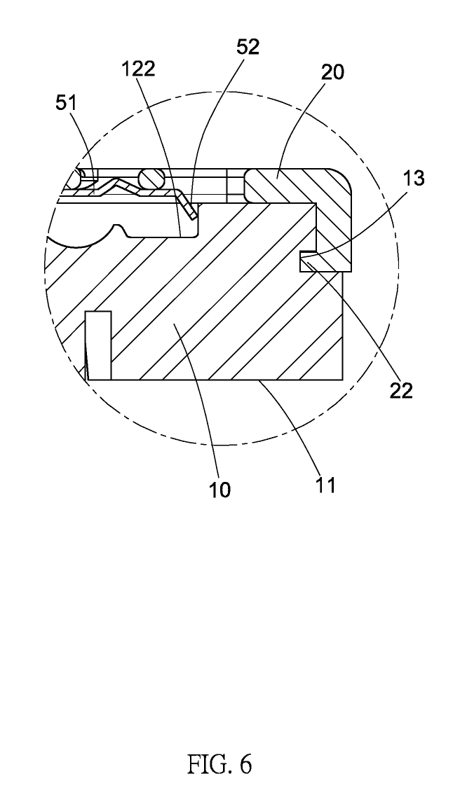

Referring to FIGS. 4 to 6, a brake shoe device for a bicycle in accordance with a second preferred embodiment of the invention is shown. The characteristics of the second preferred embodiment are discussed in detail below.

A brake pad assembly 10 includes a surface 11 facing a rim of a bicycle wheel, two limit members 12 on left and right sides of an opposite surface respectively in which the left limit member 12 has a cavity 122 and the right limit member 12 has a hole 121, and two grooves 13 on top and bottom of the limit members 12 respectively.

A support 20 includes an intermediate hole 21, two grooved rails 22 on top and bottom of an inner surface respectively, and a threaded hole 23 through the right side.

A hollow member 50 includes an extension 51 having a latched end 52. The hollow member 50 is disposed in the intermediate hole 21 and the latched end 52 urges against the cavity 122.

A bolt and nut assembly 30 includes a washer 32, a nut 33 through both the hollow member 50 and the intermediate hole 21, and a bolt 31 driven through the washer 32 and the nut 33 to fasten the bolt and nut assembly 30 and the support 20 together.

The brake pad assembly 10 and the support 20 are positioned by sliding the grooves 13 along the grooved rails 22 respectively. Further, a screw 40 is driven through the threaded hole 23 into the hole 121 to fasten the support 20 and the brake pad assembly 10 together.

While the invention has been described in terms of preferred embodiments, those skilled in the art will recognize that the invention can be practiced with modifications within the spirit and scope of the appended claims.

What is claimed is:

1. A brake shoe device for a bicycle comprising:
a brake pad assembly including a surface, right and left limit members on an opposite surface respectively wherein the left limit member has a cavity and the right limit member has a hole, and two grooves on top and bottom of the right and left limit members respectively;
a support including an intermediate hole, two grooved rails on top and bottom of an inner surface respectively, and a threaded hole through a right side;
a bolt and nut assembly including a nut in the intermediate hole, and a bolt driven through the nut to fasten the bolt and nut assembly and the support together wherein the brake pad assembly and the support are positioned and the grooves are disposed in the grooved rails respectively; and
a threaded fastener driven through the threaded hole into the hole of the right limit member to fasten the support and the brake pad assembly together.

2. The brake shoe device of claim 1, further comprising a hollow member including an extension having a latched end wherein the hollow member is disposed in the intermediate hole, the latched end urges against the cavity, and the nut is further through the hollow member.
